(19) United States
(12) Patent Application Publication
(10) Pub. No.: US 2025/0285008 A1
(43) Pub. Date: Sep. 11, 2025

(54) EXTRACTING WEAKLY CORRELATED RULES FROM SINGLE-TREE MACHINE LEARNING MODELS

(71) Applicant: PAYPAL, INC., San Jose, CA (US)

(72) Inventors: Charles Poli, Guildford (GB); Shreekanthadatta Eligar, Hyderabad (IN)

(21) Appl. No.: 18/598,972

(22) Filed: Mar. 7, 2024

(51) Int. Cl. G06N 20/00

(52) U.S. Cl. CPC G06N 20/00

(57) ABSTRACT

Data associated with a plurality of transactions is accessed. Based on the data, a first tree-based machine learning model (e.g., a gradient boosted tree-based model) is generated that contains a plurality of first nodes and a plurality of first branches interconnecting the plurality of first nodes. A first rule is extracted from the first tree-based machine learning model. The data is adjusted after the first rule has been extracted. Based on the adjusted data, a second tree-based machine learning model (e.g., a gradient boosted tree-based model) is generated that contains a plurality of second nodes and a plurality of second branches interconnecting the plurality of second nodes. A second rule is extracted from the second tree-based machine learning model. The second rule and the first rule have a correlation below a specified threshold, for example, at or close to zero.

### BACKGROUND

### Field of the Invention

The present application generally relates to machine learning. More particularly, the present application involves improving machine learning efficiency and prediction accuracy by reducing correlations between different rules extracted from a machine learning model.

### Related Art

Over the past several decades, rapid advances in integrated circuit fabrication and wired/wireless telecommunications technologies have brought about the arrival of the information age, where electronic activities and/or online transactions are becoming increasingly more common. Machine learning has been used to train models that can be used to make predictions, such as potential fraud or risks associated with a transaction. For example, a plurality of different rules may be extracted from machine learning model training, and these rules may then be used to make the predictions or decisions (e.g., with respect to fraud or risks) associated with a transaction, such as content access, a data transfer, or a purchase transaction. However, often times these rules may have overlapping coverage. In other words, some of the rules may be highly correlated with other rules. As a result, it may be difficult to determine which rule was used to make a particular prediction or decision. Therefore, although existing machine learning processes are generally adequate for their intended purposes, they have not been entirely satisfactory in every aspect. What is needed is an improved machine learning process that can reduce the degree of correlation among the different rules, which in turn can improve the accuracy of the predictions made by the trained model.

### BRIEF DESCRIPTION OF THE FIGURES

FIG. 1 is a block diagram of a networked system according to various aspects of the present disclosure.

FIG. 2 illustrates an example machine learning process according to various aspects of the present disclosure.

FIGS. 3-4 illustrate example tree-based machine learning models according to embodiments of the present disclosure.

FIG. 5 illustrates a table showing degrees of correlation between different machine-generated rules according to embodiments of the present disclosure.

FIG. 6 illustrates an example artificial neural network according to various aspects of the present disclosure.

FIG. 7 is a simplified example of a cloud-based computing architecture according to various aspects of the present disclosure.

FIG. 8 is a flowchart illustrating a machine learning process according to various aspects of the present disclosure.

FIG. 9 illustrates a computer system according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to an improved machine learning process, in which weakly correlated rules (e.g., a correlation between each pair of rules is close to zero or below a certain threshold) are extracted from single-tree machine learning models, where the weakly correlated rules may be used to make predictions and/or decisions associated with a transaction, such as, but not limited to, content access, data transfers, purchase transactions, and fund transfers. In more detail, a rule may describe a set of conditions that, if satisfied (or not satisfied), may trigger a determination or even an action. For example, a rule may specify that, if a prospective transaction occurs outside a predefined geographical location, and that a monetary amount of the prospective transaction is larger than a predefined threshold, then a determination may be made that the prospective transaction is likely fraudulent. In addition to (or in lieu of) such a determination, the rule may also specify an action to be taken with respect to the prospective transaction, such as an action to decline the prospective transaction, and/or request additional verification details before authorizing the prospective transaction. Therefore, it can be seen that rules may be useful in an Internet-based environment, such as in detecting malicious electronic attacks (e.g., computing hacking), evaluating risks (e.g., the risk of offering a financial product to an entity), and/or identifying fraud (e.g., phishing, spoofing, identity theft, etc.).

However, conventional schemes for generating the rules still have shortcomings. For example, rules are typically generated using a machine learning model that is comprised of a plurality/collection of trees, where each branch of a tree is then converted into a rule. As a result, the numerous generated rules (generated by the machine learning model) are highly correlated with one another (e.g., one model, same data and same target values). In other words, many of these rules share substantial similarities and may have overlapping coverage. As a result, multiple rules may be triggered in detecting a malicious activity, evaluating a risk of a transaction, or identifying a presence of fraud. Since it may be difficult to attribute the detection/evaluation/identification to any single particular rule, there may be an insufficient amount of transparency and/or simplicity needed to understand the determination/predictions made based on the rules generated by conventional schemes. In addition, it may take substantial amount of computing resources to train an ensemble model to generate the numerous rules. When new patterns emerge (e.g., new malicious attack patterns or new fraud patterns), the existing rules may not be capable of detecting the new patterns, and it is expensive and time consuming to retrain the ensemble model to account for the new patterns. Consequently, the conventional schemes of rule generation may have inadequate performance.

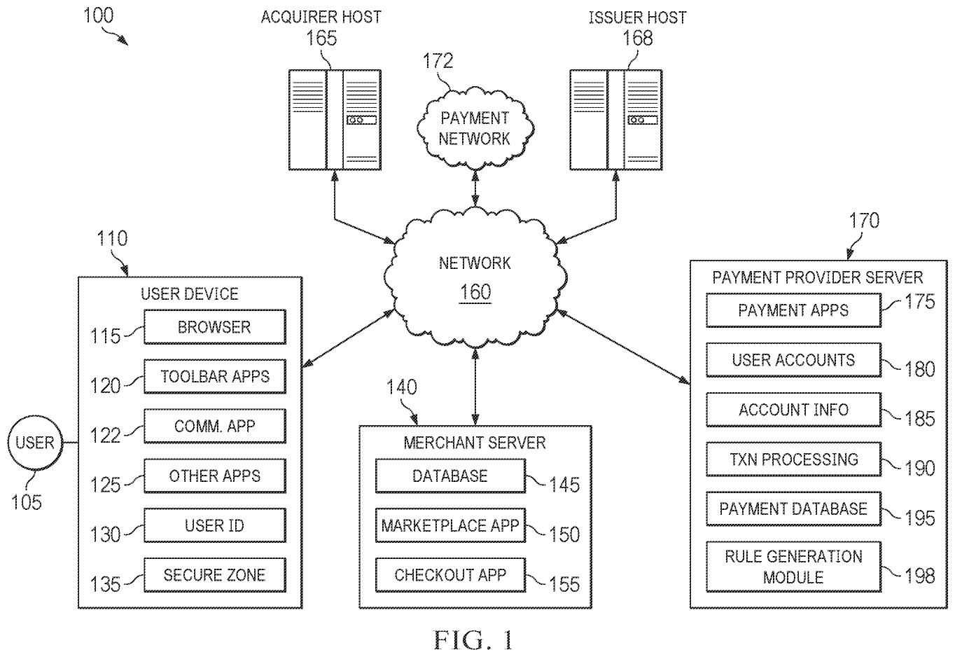

The present disclosure overcomes the above problems by generating weakly correlated rules via the training of single-tree machine learning models. In particular, the single-tree model may be trained on different target values and then generate different rules. In some embodiments, the training is done via a plurality of cycles, and each training cycle generates a different rule. The training data and the configuration of the single-tree machine learning model may also be adjusted from one training cycle to the next. As a result, the resulting rules have a low degree of correlation (e.g., below a specified numerical threshold) among themselves. When these rules are deployed in the real world, the detection of malicious activity or fraud is typically based on the triggering of a single rule, as opposed to multiple rules. As such, the rule generation scheme herein offers enhanced transparency and simplicity. Furthermore, the single-tree machine learning models are easy and inexpensive to train. Therefore, when new patterns emerge, the machine learning models herein can be quickly retrained to account for the new patterns, which also saves valuable electronic resources (e.g., electronic memory storage, computer processor usage, telecommunications network bandwidth) in the process. The various aspects of the present disclosure are discussed in more detail with reference to FIGS. 1-9.

FIG. 1 is a block diagram of a networked system 100 or architecture suitable for conducting electronic online transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, an issuer host 168, and a payment network 172 that are in communication with one another over a network 160. Payment provider server 170 may be maintained by a digital wallet provider (e.g., a payment service provider), such as PayPal™, Inc. of San Jose, CA. A user 105, such as a consumer or a customer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials as a proxy to user payment credentials based on user 105's credentials/status in the payment providers system/age/risk level and other similar parameters.

Still referring to FIG. 1, merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

The merchant server 140 may also host a website for an online marketplace, where sellers and buyers may engage in purchasing transactions with each other. The descriptions of the items or products offered for sale by the sellers may be stored in the database 145. The merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, third party financial service providers, such as associated with payment provider server 170, credit cards, debit cards, checks, money orders, or the like.

Payment provider server 170 may be maintained, for example, by an online digital wallet provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing a transaction for the user 105, such as an order and payment using various selected funding instruments, as described herein. As such, transaction processing application 190 may store details of a transaction from individual users, including funding source used, credit options available, etc. Payment application 175 may be further configured to determine the existence of and to manage accounts for user 105, as well as create new accounts if necessary.

According to various aspects of the present disclosure, a rule generation module 198 may also be implemented on the payment provider server 170. As will be discussed in greater detail below, the rule generation module 198 trains a single-tree machine learning model, and each training cycle generates a different rule that can be used later for detecting malicious activity, predicting an outcome, and/or identifying fraud, etc. In some embodiments, the single-tree is constructed based on data corresponding to a plurality of historical transactions, and each training cycle may include traversing all the potential paths of the single-tree.

As a part of each training cycle, an evaluation is made as to which of the tree-traversal paths offers a best split of the data in terms of catching a transaction with a predefined metric, such as a charge back that occurs when a merchant has to issue a refund to a customer, or another type of predefined event. In some embodiments, the predefined metric is labeled with a predefined binary status. For example, transactions where charge back occurred are labeled with a binary status of 1, whereas the transactions where charge back did not occur are labeled with a binary status of 0. Once the rule is generated from the training cycle, the transactions with the occurrence of the charge back that have been caught by the rule will now have the binary status flipped from 1 to 0. This is because whatever rule is to be generated from the subsequent training cycles should not be trained to catch these transactions again, since they have already been caught by an existing rule. In this manner, the different rules generated by the different training cycles may have reduced correlation with one another.

In any case, the above process may be repeated for a number of training cycles, and it may be terminated either after a predefined number of training cycles have been completed, or it may be terminated in response to a determination that none of the transactions have the binary status of 1 for the predefined metric, meaning that all the target transactions have been caught by the machine-generated rules at this point. As discussed above, the rules are generated from single-tree models, which are simpler than ensemble models that involve a large number of trees. As such, less computer resources (e.g., computer processing power, electronic memory usage, telecommunication network bandwidth) are used to perform the machine learning model training. In addition, the machine learning models can be trained faster and more efficiently. For at least these reasons, the system 100 herein offers an improvement in computer technology. Furthermore, the low degree of correlation between the rules generated herein means that more transparent and more accurate predictions can be made. Since inaccurate predictions would have otherwise required additional computing resources to remedy or address the sub-optimal outcomes resulting from the inaccurate output of the machine learning models, the enhanced accuracy offered by system 100 herein further amounts to an improvement in computer technology. The machine learning scheme of the present disclosure is also a practical application of the idea of improving accuracy and performance in machine learning. For example, since the machine generated rules are weakly correlated (or not correlated at all) with one another, whatever predictions or determinations in a machine learning context can be attributed to a specific rule, which may be practical in justifying and/or explaining the predictions and/or determinations, particularly when such predictions and/or determinations could otherwise be perceived as being discriminatory against members of a protected class.

It is noted that although the rule generation module 198 is illustrated as being separate from the transaction processing application 190 in the embodiment shown in FIG. 1, the transaction processing application 190 may implement some, or all, of the functionalities of the rule generation module 198 in other embodiments. In other words, the rule generation module 198 may be integrated within the transaction processing application 190 in some embodiments. In addition, it is understood that the rule generation module 198 (or another similar program) may be implemented on the merchant server 140, on a server of any other entity operating a social interaction platform, or even on a portable electronic device similar to the user device 110 (but may belong to an entity operating the payment provider server 170) as well.

It is also understood that the rule generation module 198 may include one or more sub-modules that are configured to perform specific tasks. For example, in some embodiments, the rule generation module 198 may include a sub-module configured to access the machine learning training data, another sub-module configured to generate each of the tree models, a further sub-module configured to execute each cycle (e.g., for each different tree) of the machine learning training process, and yet another sub-module configured to make predictions based on the trained machine learning models, etc. For reasons of simplicity, the different sub-modules (if they are implemented as such) are not specifically illustrated in FIG. 1.

Still referring to FIG. 1, the payment network 172 may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Acquirer host 165 may be a server operated by an acquiring bank or other financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

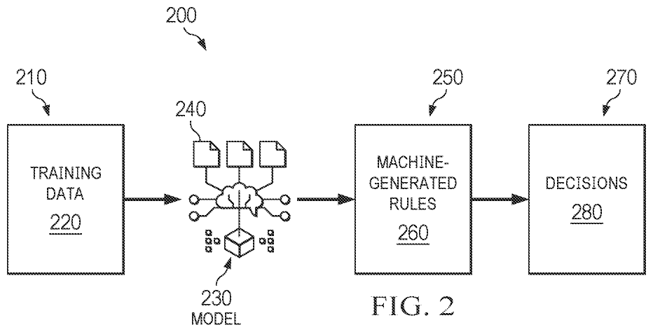

Referring now to FIG. 2, a simplified block diagram of a process flow 200 of a machine learning process is illustrated according to an embodiment of the present disclosure. The process flow 200 begins with a step 210, in which training data 220 is accessed. In some embodiments, the training data 220 is stored in an electronic storage, such as a Hadoop Distributed File System (HDFS), and the step 210 includes retrieving the training data 220 from the electronic storage. Note that although Hadoop is used as an example herein, the concepts of the present disclosure are not limited to Hadoop systems. For example, the concepts herein may apply to other large-scale graphs, which may also be stored in Google Cloud Databases, Amazon Neptune, Neo4J, or any GPU/CPU supporting deep-learning modules. In some embodiments, the training data 220 may be generated and/or maintained by the service provider that maintains/operates the payment provider server 170 of FIG. 1.

The process flow 200 continues with a step 230, in which one or more machine learning models 240 are trained using the training data 220. In some embodiments, at least some of the machine learning models 240 comprise a tree-based model, for example, an extreme Gradient Boosting (XGBoost) model. Such a tree model may include a plurality of nodes that are connected by branches. In some embodiments, the machine learning model training of step 230 may include a plurality of training iterations or cycles, but each iteration or cycle trains a machine model composed of a single tree, as opposed to an ensemble model composed of a plurality of trees. However, it is understood that the configuration of the single tree may change from iteration to iteration.

In some embodiments, the machine learning model 240 is trained by inputting the training data 220 into a Graphics Processing Unit (GPU) module, which may include a plurality of physical GPU cards. GPU cards are especially suited for performing machine-learning-related tasks, such as model training, because GPU cards are configured for parallel processing and can carry out multiple computations simultaneously. Of course, it is understood that one or more Central Processing Unit (CPU) modules may be used in lieu of, or in combination with, the GPU modules to perform the machine learning model training of step 230.

The process flow 200 continues with a step 250, in which a plurality of machine-generated rules 260 are obtained as a result of the training of the machine learning models 240. As discussed above, the training of the machine learning models 240 (e.g., step 230) may comprise a plurality of training iterations, where each training iteration trains a different tree. In that case, the result of the training of each tree comprises a different rule. In some embodiments, each rule my be identified by traversing the various nodes of the tree according to a plurality of possible traversal permutations (e.g., different paths for traversing the nodes of the tree), and the traversal that yields the best result according to a predefined performance indicator (e.g., a gain calculated by the XGBoost model) may be identified as the best rule.

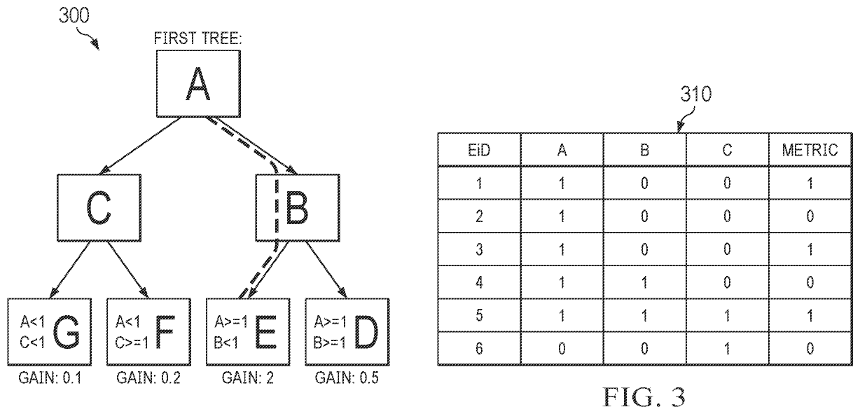

Each rule that is extracted according to the above process may correspond to a set of circumstances and/or conditions associated with a specific type of event or decision. For example, a rule may specify that a transaction between two parties is deemed potentially fraudulent when the transaction occurs in a given geographical region, using a certain type of machine to conduct the transaction, where one of the parties has a certain type of transaction history, and with the transaction exceeding a specified monetary amount. Of course, multiple machine-generated rules 260 may be extracted in step 250 from the machine learning models 240. According to the various aspects of the present disclosure, the machine-generated rules 260 have a low degree (e.g., below a specified threshold) of correlation among themselves. In some embodiments, each of the rules of the machine-generated rules 260 is substantially non-correlated with any of the other rules. This aspect of the present disclosure will be discussed below in more detail with reference to FIGS. 3-4.

Still referring to FIG. 2, the process flow 200 continues with a step 270, in which one or more decisions 280 are generated based on the machine-generated rules 260 obtained by step 250. In some embodiments, the one or more decisions 280 may include a determination of whether a transaction is likely fraudulent. For example, an entity (e.g., the entity operating and/or maintaining the payment provider server 170 or the entity operating and/or maintaining the merchant server 140) may receive a transaction request to process a prospective transaction between a party A (e.g., a user) and a party B (e.g., a merchant). The transaction request may include various transaction details such as place of the prospective transaction, device(s) being used to request and/or conduct the prospective transaction, a monetary amount of the prospective transaction, and/or a transaction history of the party A or the party B, etc. Based on these transaction details, the entity may determine whether or not one or more of the machine-generated rules 260 are triggered. For example, if the transaction details substantially match with the circumstances stipulated by a particular rule, then that rule may be considered triggered by the prospective transaction. The triggering of the particular machine-generated rule 260 may lead to a decision 280 that the prospective transaction is likely fraudulent (or exceeds a predicted likelihood of fraud) and therefore should be declined, or a decision 280 that additional details may be needed to further verify the validity of the prospective transaction. Of course, the decisions 280 are not limited to determinations of fraud in an electronic commerce context. As other examples, the decisions 280 may include: a decision to approve or deny a credit line or a loan for a party applying for the credit line or the loan, a detection of an electronic attack (e.g., computer hacking), a decision to allow access of certain data or content, or an identification of phishing, spoofing, identity theft, etc.

FIGS. 3-4 each illustrate a simplified block diagram of a tree-based machine learning model according to various aspects of the present disclosure. In each of FIGS. 3 and 4, an iteration of a tree-traversal is performed as a part of the machine learning process herein, where a rule is extracted from each iteration of the tree-traversal, as discussed in more detail below.

Referring to FIG. 3, the block diagram of a simplified tree 300 is illustrated. The tree 300 may be a binary tree constructed based on a set of transactions included as a part of the training data 220 discussed above with reference to FIG. 2. As a simplified example shown in a table 310 (also illustrated in FIG. 3), these transactions may include transactions with electronic identifiers (EiD) 1, 2, 3, 4, 5, and 6. The tree 300 may also be constructed based on a gradient-boosted decision-tree-based machine learning model, for example, Light Gradient Boosting Machine (LightGBM) or eXtreme Gradient Boosting (XGBoost). Note that the tree 300 is a single tree herein, as opposed to an ensemble of a plurality of trees.

The tree 300 includes a plurality of interconnected nodes, for example, nodes A, B, C, D, E, F, and G. Each of the nodes may represent a binary condition (e.g., the condition can be satisfied or not satisfied), and the connections between the nodes represent a satisfaction of the condition or a dissatisfaction of the condition. For example, the node A may represent a condition of: “is the total number of transactions conducted by a party involved the prospective transaction greater than a specified threshold (e.g., threshold=100) within a given time window (e.g., the last 24 hours)?” If the answer to the condition of node A is yes, then the tree 300 branches off to the node B. Thus, the branch connecting the nodes A and B represents a satisfaction of the condition presented in node A. However, if the answer to the condition of node A is no, then the tree 300 branches off to the node C. Thus, the branch connecting the nodes A and C represents a dissatisfaction of the condition presented in node A.

Nodes B and C may represent their own conditions that are different from the condition represented by node A. For example, node B may represent a condition of: “is a predefined risk score (calculated based on historical transaction data) for a given party involved in the prospective transaction greater than a specified threshold score (e.g., threshold score=700)?” If the answer to the condition of node B is yes, then the tree 300 branches off to the node D. But if the answer to the condition of node B is no, then the tree 300 branches off to the node E. Meanwhile, node C may represent a condition of: “does the prospective transaction originate in the U.S.A.?” If the answer to the condition of node C is yes, then the tree 300 branches off to the node F. But if the answer to the condition of node C is no, then the tree 300 branches off to the node G.

Note that the branching possibilities based on the satisfaction/dissatisfaction of the conditions are also represented in the table 310 with binary values. In the illustrated embodiment, the table 310 lists a binary value of 1 or 0 corresponding to the satisfaction of the condition or the dissatisfaction of the condition, respectively. For example, for the transaction corresponding to EiD 1, the condition A is satisfied (represented by the binary value of 1 under the condition A for transaction EiD 1), the condition B is dissatisfied (represented by the binary value of 0 under the condition B for transaction EiD 1), and the condition C is dissatisfied as well (represented by the binary value of 0 under the condition C for transaction EiD 1).

The table 310 further lists a predefined metric for each of the transactions (e.g., EiDs 1-6). In the illustrated embodiment, the predefined metric may include a charge back (CB), which may correspond to a situation where a payment for a past transaction was refunded/returned to a customer involved in the past transaction after the customer successfully disputes the transaction with the merchant involved in the past transaction. In other embodiments, the predefined metric may include other refunds not tied to a charge back, a transaction decline, a presence of fraud, an indicator of a malicious electronic attack, etc. The table 310 lists a binary value of 1 to indicate that the charge back (as an example metric) did occur for the transaction (e.g., transactions corresponding to EiDs 1, 3, and 5 in this simplified example). On the other hand, the table 310 lists a binary value of 0 to indicate that the charge back (as an example metric) did not occur for the transaction (e.g., transactions corresponding to EiDs 2, 4, and 6 in this simplified example). Regardless of what the particular type of metric entails, it is understood that the rules to be extracted from the machine learning processes herein are specifically configured to detect or otherwise catch transactions with the target metric (e.g., prospective future transactions in which a charge back is likely to occur, if charge back is the target metric).

The tree 300 may be traversed via a plurality of potential paths, where each path may correspond to (or represent) a potential rule. For example, a first path may correspond to a traversal of the tree 300 by going through the nodes A, B, and D, which represents a satisfaction of the condition of node A as well as a satisfaction of the condition of node B. In other words, node D is associated with A>=1 and B>=1 in mathematical terms. A second path may correspond to a traversal of the tree 300 by going through the nodes A, B, and E, which represents a satisfaction of the condition of node A but a dissatisfaction of the condition of node B. In other words, node E is associated with A>=1 and B<1 in mathematical terms. A third path may correspond to a traversal of the tree 300 by going through the nodes A, C, and F, which represents a dissatisfaction of the condition of node A but a satisfaction of the condition of node C. In other words, node F is associated with A<1 and C>=1 in mathematical terms. A fourth path may correspond to a traversal of the tree 300 by going through the nodes A, C, and G, which represents a dissatisfaction of the condition of node A as well as a dissatisfaction of the condition of node C. In other words, node G is associated with A<1 and C<1 in mathematical terms.

For each of the potential traversal paths of the tree 300, a predefined performance indicator is calculated. The predefined performance indicator may indicate a performance of each corresponding traversal path in terms of splitting the tree 300 so as to arrive at the metric. For example, the predefined performance indicator may indicate how well the corresponding traversal path (e.g., A→B→D, A→B→E, A→C→F, or A→C→G) achieves a result where the charge back (as an example metric) has a binary value of 1, which means that the charge back occurred. In some embodiments, the predefined performance indicator may be a gain calculation as an algorithm embedded in the XGBoost model.

In the case of the tree 300, the traversal path A→B→E yields the best gain value of 2, which is greater than the gain value of 0.5 for the traversal path A→B→D, or the gain value of 0.2 for the traversal path A→C→F, or gain value of 0.1 for the traversal path A→C→G. These gain values are justified by the fact that the path A→B→E catches two transactions EiD 1 and EiD 3 where the charge back occurred (e.g., the metric for transactions EiD 1 and EiD 3 having the binary value of 1). Meanwhile, the next best traversal path A→B→D (based on the fact that its gain of 0.5 is less than the gain of 2 but greater than the gains of 0.2 and 0.1) catches just one transaction EiD 5 where the charge back occurred (e.g., the metric for transaction EiD 5 having the binary value of 1). In comparison, the traversal paths A→C→F and A→C→G had low gain values of 0.2 and 0.1, respectively, because neither of them caught any of the charge backs (e.g., the metric for these paths all have a binary value of 0). Since the traversal path A→B→E with the greatest gain is the best candidate for catching the charge back, it may be hereinafter used as one of the machine-generated rules 260. In other words, the potential traversals of the tree 300 based on the iteration shown in FIG. 3 yields the machine-generated rule 260 represented by the condition of A being satisfied and the condition of B being dissatisfied.

Referring now to FIG. 4, a block diagram of another simplified tree 400 and the corresponding table 410 are illustrated. Similar to the tree 300 of FIG. 3, the tree 400 may be constructed based on a set of transactions included as a part of the training data 220 discussed above with reference to FIG. 2. For example, the tree 400 may be constructed based on the same set of transactions that were used to construct the tree 300. In this simplified example herein, this means that the tree 300 and the tree 400 are both based on the transactions EiD 1 through EiD 6. However, the metric statuses of the transactions caught by the rule of FIG. 3 are flipped (e.g., changed from the binary value of 1 to the binary value of 0). In this example, the transactions EiD 1 and EiD 3 were caught by the rule (generated by the tree 300 of FIG. 3) corresponding to the traversal path of A→B→E. The metric of these transactions EiD 1 and EiD 3 each had a binary value of 1 in the table 310, but now they have a binary value of 0 in the table 410. This is because it is now known that these transactions (with their specific characteristics) can be caught by the rule corresponding to the traversal path A→B→E. As such, it is no longer necessary to devise another rule to specifically catch these transactions again, and this will help reduce the correlation between the different rules. Note that the values of the rest of the table 410 will remain the same as the table 310.

As was the case for the tree 300 of FIG. 3, the tree 400 of FIG. 4 may also just comprise a single tree (as opposed to an ensemble of a plurality of trees), and it may also be constructed based on a decision-tree-based machine learning model, such as LightGBM or XGBoost. However, the tree 400 may have a different configuration of the nodes. For example, whereas the tree 300 of FIG. 3 has the node A as a top-level node and the nodes B and C at a level below the node A, the tree of FIG. B has the node B as a top-level node and the nodes A and C at a level below the node B. The re-arrangement of the positions of the nodes A, B, and C may be due to the fact the binary statuses for the transactions EiD 1 and EiD 3 have been changed. For example, since the transactions EiD 1 and EiD 3 are no longer regarded as transactions with charge backs (e.g., where charge back is the example metric), the only transaction that resulted in a charge back is the transaction EiD 5. Hence, the tree 400 should be configured in a manner such that it can be split optimally to extract a rule (e.g., corresponding to a traversal path) for catching the transaction EiD 5. Thus, whereas the arrangement of having the node A as the top-level node may work optimally for splitting the tree 300, the arrangement of having the node B as the top-level node may work optimally for splitting the tree 400.

In addition, the specific parameters associated with the conditions A, B, or C may change from the tree 300 to the tree 400 in some embodiments as well. For example, whereas the condition A in the tree 300 may represent a condition of “is the total number of transactions conducted by a party involved the prospective transaction greater than 100 within the last 24 hours?”, the condition A in the tree 400 may represent a slightly altered condition of “is the total number of transactions conducted by a party involved the prospective transaction greater than 500 within the last 24 hours?”, or a condition of “is the total number of transactions conducted by a party involved the prospective transaction greater than 100 within the last 48 hours?”, or a condition of “is the total number of transactions conducted by a party involved the prospective transaction less than 50 within the last 24 hours?” In various embodiments, the parameter of the condition that could change from one tree to the next may include the value of a specified threshold, the operator (e.g., greater than or less than?), or even the underlying variable. In other embodiments, however, the parameters of the conditions may remain the same from one tree to the next.

Similar to how the tree 300 was traversed, the tree 400 may also be traversed via a plurality of potential paths, where each path may correspond to (or represent) a potential rule. For example, a first path may correspond to a traversal of the tree 400 by going through the nodes B, C, and D, which represents a satisfaction of the condition of node B as well as a satisfaction of the condition of node C. In other words, node D is associated with B>=1 and C>=1 in mathematical terms. A second path may correspond to a traversal of the tree 400 by going through the nodes B, C, and E, which represents a satisfaction of the condition of node B but a dissatisfaction of the condition of node C. In other words, node E is associated with B>=1 and C<1 in mathematical terms. A third path may correspond to a traversal of the tree 400 by going through the nodes B, A, and F, which represents a dissatisfaction of the condition of node B but a satisfaction of the condition of node A. In other words, node F is associated with B<1 and A>=1 in mathematical terms. A fourth path may correspond to a traversal of the tree 400 by going through the nodes B, A, and G, which represents a dissatisfaction of the condition of node B as well as a dissatisfaction of the condition of node A. In other words, node G is associated with B<1 and A<1 in mathematical terms.

For each of the potential traversal paths of the tree 400, the same predefined performance indicator that was calculated for the tree 300 is calculated. For example, the gain (as an algorithm embedded in the XGBoost model) may be calculated for each of the potential traversal paths of the tree 400. The traversal path B→C→D yields a gain value of 5, the traversal path B→C→E yields a gain value of 1, the traversal path B→A→F yields a gain value of 0.2, and the traversal path B→A→G yields a gain value of 0.1. As such, the best traversal path is B→C→D, since its corresponding gain value of 5 exceeds the gain values of other potential traversal paths. This determination (that B→C→D is the best traversal path) is also justified by the fact that the traversal path of B→C→D the only traversal path that catches the transaction with the charge back, which is shown in the table 410 as the transaction EiD 5 having the binary value of 1 for its metric. As such, the traversal path of B→C→D may be hereinafter used as another one of the machine-generated rules 260. In other words, the potential traversals of the tree 400 based on the iteration shown in FIG. 4 yields the machine-generated rule 260 represented by the condition of B being satisfied and the condition of C also being satisfied.

In the illustrated embodiment, the machine learning process for extracting the rules may terminate after the iteration involving the tree 400. This is because after the binary status of the metric is changed from 1 to 0 for the transaction EiD 5 (which will be done at the end of the training cycle of FIG. 4), there are no more transactions whose metric value is a binary 1. In other words, the two extracted rules (e.g., the rule corresponding to the traversal of A→B→E of the tree 300 and the rule corresponding to the traversal of B→C→D of the tree 400) are capable of catching all the transactions of interest (e.g., the transactions where a charge back have occurred), which are transactions EiD 1, EiD 3, and EiD 5 in this simplified example. However, in a real-world scenario, the number of transactions based on which a tree model similar to the trees 300 or 400 is constructed may be far greater than six. For example, a tree constructed based on a real-world transaction dataset may include thousands, if not hundreds or thousands, or millions of transactions. As such, the above iterations (e.g., traversing a tree, extracting a best rule based on the tree traversal, flipping the binary value of the target metric of the transactions caught by the extracted rule, so as to prepare the table for a subsequent tree traversal) may be performed more than just twice. For example, depending on the number of the transactions used and the complexity of the associated dataset and/or conditions, five to ten rules may be extracted from the machine learning process herein.

Regardless of the number of iterations (and thus the corresponding number of rules extracted), it is understood that each rule is still extracted as a result of a respective iteration of a single (and different) tree. The extracted rules have a low degree of correlation amongst themselves. That is, the degree of correlation between each extracted rule and any other extracted rule is below a predetermined threshold. In some embodiments, the degree of correlation may be measured via a Jaccard similarity coefficient, which is a statistic used for gauging the similarity and diversity of sample sets. In some other embodiments, the degree of correlation may be measured via a Pearson Correlation Coefficient.

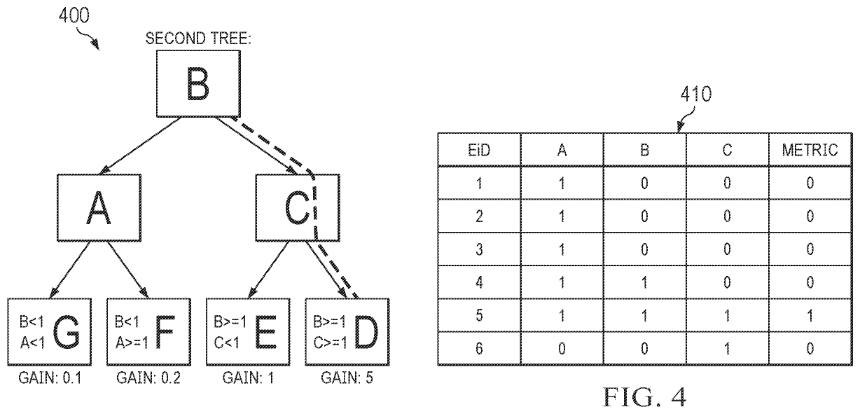

Referring now to FIG. 5, a table 500 illustrates a degree of correlation among various example machine-generated rules 260. In more detail, table 500 includes three example rules: rule 1, rule 2, and rule 3, where each of the rules is extracted via the process described above with reference to FIGS. 3-4. For example, rule 1 may be extracted based on a traversal of a first tree similar to the tree 300 but with a greater depth (e.g., having more than three levels), rule 2 may be extracted based on a traversal of a second tree similar to the first tree, but with the binary status flipped for the target metric (e.g., charge back) of transactions that had been caught by rule 1, and rule 3 may be extracted based on a traversal of a third tree similar to the first tree and/or the second tree, but with the binary status flipped for the target metric of transactions that had been caught by rule 1 and/or rule 2.

As a simplified example, rule 1 may stipulate the following conditions: condition A is satisfied, condition B is satisfied, and condition C is dissatisfied; rule 2 may stipulate the following conditions: condition A is dissatisfied, condition M is satisfied, and condition N is dissatisfied; rule 3 may stipulate the following conditions: condition X is satisfied, condition Y is dissatisfied, and condition Z is satisfied. Note that some of the rules may each include a certain condition (e.g., rule 1 and rule 2 may each include the condition A), though the satisfaction criterion for these shared conditions may or may not be the same in the different rules. In other embodiments, the rules may not share the same conditions.

The top row of the table 500 lists the three example rules 1-3, and the leftmost column of the table 500 also lists the three example rules 1-3. The table 500 also lists the Jaccard similarity coefficient (as an example indicator for the degree of correlation) between any of the two rules. For example, the Jaccard similarity coefficient between the rule 1 and rule 1 is 1.00, meaning that the rule 1 is 100% correlated with itself, which is intuitive. The same 100% correlation is also true for the rule 2 with itself, and rule 3 with itself. However, the Jaccard similarity coefficient between rule 1 and rule 2 is 0.01, which means rule 1 and rule 2 have a very low degree of correlation between each other. For comparison purposes, the rules generated by conventional systems often have a Jaccard similarity coefficient that exceeds 0.4. The Jaccard similarity coefficient between rule 1 and rule 3 is 0.00, and the Jaccard similarity coefficient between rule 2 and rule 3 is also 0.00, which means that the degree of correlation between rule 1 and rule 3, or between rule 2 and rule 3, is also 0.00. For example, rule 1 and rule 3 may not be correlated at all, and the same is true for rule 2 and rule 3.

In any case, it is understood that the values shown in the table 500 are merely examples, and that the actual Jaccard similarity coefficient values between any two machine-generated rules 260 in a real-world scenario may be different, though they may still have a correlation below a predefined threshold, such as below 0.1 in terms of Jaccard similarity coefficient. In some embodiments, if the degree of correlation between any two machine-generated rules in a real-world scenario exceeds the predefined threshold, then the above process described with reference to FIGS. 3-4 may be repeated (but with altered conditions) until the end result shows that all of the rules can achieve a degree of correlation below the predefined threshold with any of the other rules. For example, the conditions may be changed, and/or the parameters of the conditions may be changed, to effectuate the generation of new rule(s) that can achieve the lower-than-specified degree of correlation with the other rules.

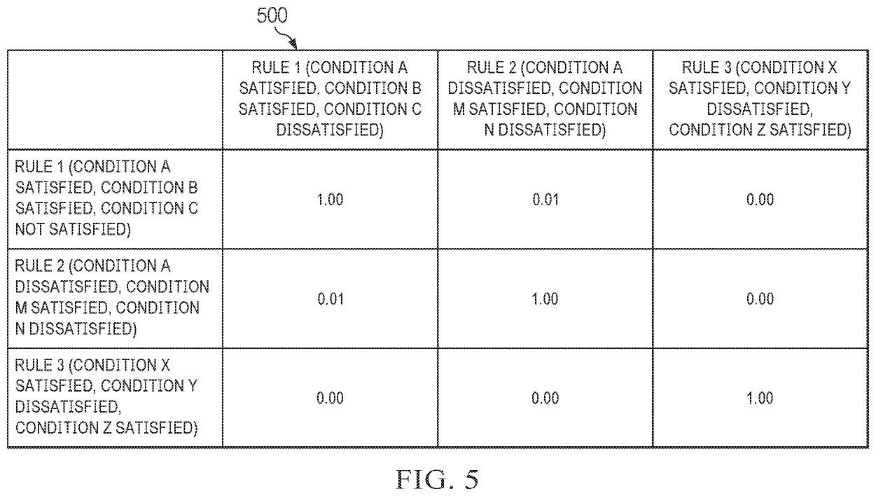

FIG. 6 illustrates an example artificial neural network 600 that may be used to implement certain aspects of the present disclosure (e.g., the tree models). As shown, the artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 used to implement a part of the rule generation module 198, and the rule generation module 198 may include as many hidden layers as necessary.

In this example, the artificial neural network 600 receives a set of input values and produces an output value. Each node in the input layer 602 may correspond to a distinct input value. For example, when the artificial neural network 600 is used to implement a machine learning module, each node in the input layer 602 may correspond to a distinct data feature.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. When the artificial neural network 600 is used to implement the machine learning module, the output value produced by the artificial neural network 600 may indicate a likelihood of an event (e.g., occurrence of fraud, or a loan becoming bad due to missed payments or a loan default).

The artificial neural network 600 may be trained by using training data. For example, the training data herein may be the previous occurrences of fraud, defaults, past due payments, or bad loans and their corresponding user data. By providing training data to the artificial neural network 600, the nodes 616-618 in the hidden layer 604 may be trained (adjusted) such that an optimal output is produced in the output layer 606 based on the training data. By continuously providing different sets of training data, and penalizing the artificial neural network 600 when the output of the artificial neural network 600 is incorrect (e.g., when the determined (predicted) likelihood of fraud or a bad loan is inconsistent with whether fraud occurred or the loan actually became bad, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

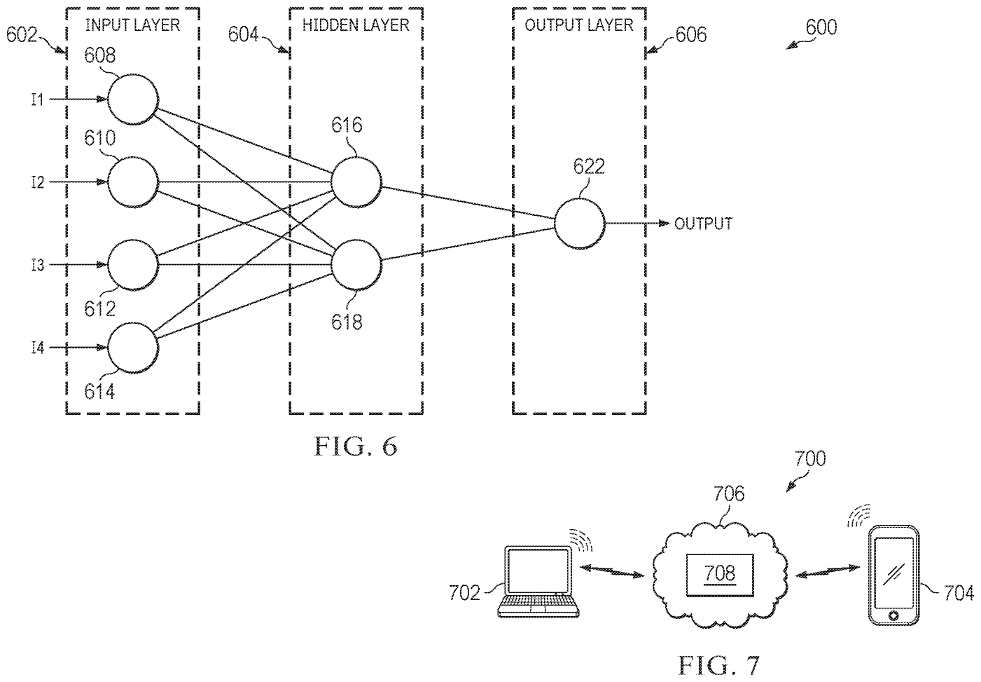

FIG. 7 illustrates an example cloud-based computing architecture 700, which may also be used to implement various aspects of the present disclosure. The cloud-based computing architecture 700 includes a mobile device 704 (e.g., the user device 110 of FIG. 1) and a computer 702 (e.g., the merchant server 140 or the payment provider server 170), both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing may be performed by the cloud-based resources 708. However, other divisions of responsibility are also possible in various embodiments. In some embodiments, using this cloud architecture, the rule generation module 198 may reside on the merchant server 140 or the payment provider server 170, but its functionalities can be accessed or utilized by the mobile device 704, or vice versa.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for performing the various processes discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices. Similarly, a merchant or another user may access the cloud-based resources 708 from any number of suitable mobile or non-mobile devices. Furthermore, the cloud-based resources 708 may accommodate many merchants and users in various embodiments.

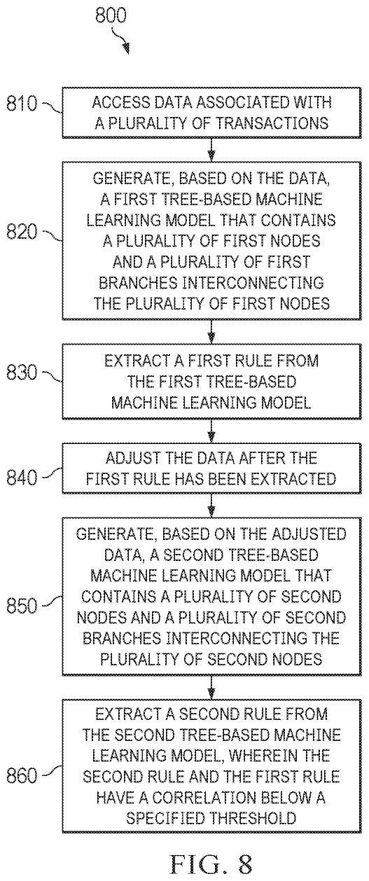

FIG. 8 is a flowchart illustrating a method 800 for a machine learning process according to various aspects of the present disclosure. The various steps of the method 800, which are described in greater detail above, may be performed by one or more electronic processors, for example by the processors of a computer of an entity that may include (but are not limited to): a payment provider, a business analyst, or a merchant. The networked system described with respect to FIG. 1 is an example of a system that can perform the method 800. For example, the steps 810-860 of the method 800 may be performed by the payment provider server 170 of FIG. 1. In some embodiments, at least some of the steps of the method 800 may be performed by the rule generation module 198 discussed above. For example, steps 810-860 of the method 800 may be performed by the rule generation module 198 of FIG. 1.

The method 800 includes a step 810 to access a data associated with a plurality of transactions. For example, the step 810 may include the step 210 discussed above with reference to FIG. 1, where the training data 220 may be accessed.

The method 800 includes a step 820 to generate, based on the data, a first tree-based machine learning model that contains a plurality of first nodes and a plurality of first branches interconnecting the plurality of first nodes. In some embodiments, the first tree-based machine learning model is a gradient-boosted tree machine learning model that contains a unique tree composed of the plurality of first nodes. In some embodiments, each of the first nodes or each of the second nodes represents a different true or false condition. In some embodiments, the first tree-based machine learning model may comprise the tree 300 of FIG. 3.

The method 800 includes a step 830 to extract a first rule from the first tree-based machine learning model. In some embodiments, the first rule is a best rule, for example, a rule with the highest information gain. In some embodiments, the first rule may correspond to the traversal of A→B→E of the tree 300 of FIG. 3.

The method 800 includes a step 840 to adjust the data after the first rule has been extracted. In some embodiments, the data adjustment may include flipping the binary bits of the transactions where the metric (e.g., charge back) was previously labeled with a binary status of 1 and that were caught by the first rule. These transactions now have their binary bits flipped to 0 for that metric.

The method 800 includes a step 850 to generate, based on the adjusted data, a second tree-based machine learning model that contains a plurality of second nodes and a plurality of second branches interconnecting the plurality of second nodes. In some embodiments, the second tree-based machine learning model is a gradient-boosted tree machine learning model that contains a unique tree composed of the plurality of second nodes. In some embodiments, the second tree-based machine learning model may comprise the tree 400 of FIG. 4.

The method 800 includes a step 860 to extract a second rule from the second tree-based machine learning model. In some embodiments, the second rule may correspond to the traversal of B→C→D of the tree 400 of FIG. 4. The second rule and the first rule have a correlation below a specified threshold (e.g., at or close to zero). In some embodiments, the first rule and the second rule are non-correlated with each other. In some embodiments, the correlation between the first rule and the second rule is measured by a Jaccard similarity coefficient or a Pearson Correlation Coefficient.

In some embodiments, the data for each of the transactions comprises a metric having either a first binary status or a second binary status (e.g., true or false, or mathematically represented by 1 or 0). In some embodiments, the metric comprises a charge back associated with the transaction or a decline of the transaction. The first rule is extracted based on a traversal of the first tree-based machine learning model through a group of the first nodes. A subset of the first nodes in the group is identified as having the first binary status for the metric. The adjusting the data comprises changing, for the subset of the first nodes, the first binary status to the second binary status. In some embodiments, the first rule is extracted by: identifying a plurality of potential traversals through the first tree-based machine learning model; calculating a predefined performance indicator for each of the potential traversals; and determining that the potential traversal with a highest value of the predefined performance indicator is the traversal based on which the first rule is extracted.

In some embodiments, the first tree-based machine learning model and the second tree-based machine learning model each comprises a Gradient Boosted Tree model. In some embodiments, the first tree-based machine learning model and the second tree-based machine learning model have different tree configurations.

It is understood that the method 800 herein may be performed using a supervised machine learning approach. For example, in each iteration, the target values of the True Positive detected by the rule (e.g., the True Positive may be a fraudulent transaction predicted as being bad by the rule) are switched from fraudulent to not fraudulent in order to reduce the pairwise correlation between rules to close to zero. It is also understood that additional method steps may be performed before, during, or after the steps 810-860 discussed above. For example, the method 800 may include a step of evaluating one or more further transactions at least in part by applying the first rule and the second rule to the one or more further transactions. Once rules are determined, and models are generated or accessed, decisions associated with a transaction can now be made using output predictions from the models.

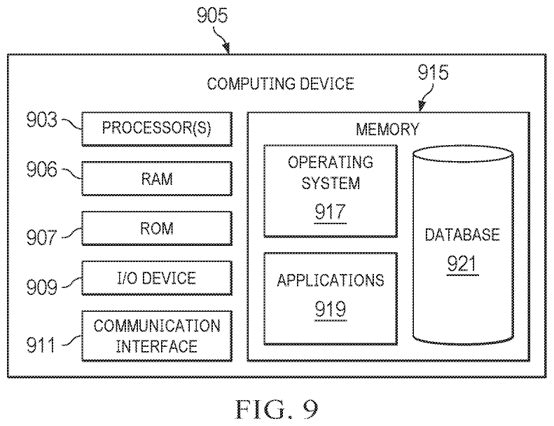

Turning now to FIG. 9, a computing device 905 that may be used with one or more of the computational systems is described. The computing device 905 may be used to implement various computing devices discussed above with reference to FIGS. 1-8. For example, the computing device 905 may be used to implement the rule generation module 198 (or portions thereof) of FIG. 1, and/or other components (e.g., the transaction processing application 190) of the payment provider server 170. Furthermore, the computing device 905 may be used to implement the user device 110, the merchant server 140, the acquirer host 165, the issuer host 168, the rule generation module 198, or portions thereof, in various embodiments. The computing device 905 may include one or more processors 903 for controlling overall operation of the computing device 905 and its associated components, including RAM 906, ROM 907, input/output device 909, communication interface 911, and/or memory 915. A data bus may interconnect processor(s) 903, RAM 906, ROM 907, memory 915, I/O device 909, and/or communication interface 911. In some embodiments, computing device 905 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 909 may include a microphone, keypad, touch screen, and/or stylus motion, gesture, through which a user of the computing device 905 may provide input, and may also include one or more speakers for providing audio output and a video display device for providing textual, audiovisual, and/or graphical output. Software may be stored within memory 915 to provide instructions to processor(s) 903 allowing computing device 905 to perform various actions. For example, memory 915 may store software used by the computing device 905, such as an operating system 917, application programs 919, and/or an associated internal database 921. The various hardware memory units in memory 915 may include volatile and nonvolatile, removable and non-removable media implemented in any method or technology for storage of information such as computer-readable instructions, data structures, program modules, or other data. Memory 915 may include one or more physical persistent memory devices and/or one or more non-persistent memory devices. Memory 915 may include, but is not limited to, random access memory (RAM) 906, read only memory (ROM) 907, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor(s) 903.

Communication interface 911 may include one or more transceivers, digital signal processors, and/or additional circuitry and software for communicating via any network, wired or wireless, using any protocol as described herein.

Processor(s) 903 may include a single central processing unit (CPU) in some embodiments, which may be a single-core or multi-core processor, or it may include multiple CPUs in other embodiments. In some embodiments, the processor(s) 903 may include one or more GPUs, in addition to, or in lieu of, the CPUs. The processor(s) 903 and associated components may allow the computing device 905 to execute a series of computer-readable instructions to perform some or all of the processes described herein. Although not shown in FIG. 9, various elements within memory 915 or other components in computing device 905, may include one or more caches, for example, CPU/GPU caches used by the processor 903, page caches used by the operating system 917, disk caches of a hard drive, and/or database caches used to cache content from database 921. For embodiments including a CPU/GPU cache, the CPU/GPU cache may be used by one or more processors 903 to reduce memory latency and access time. Processor(s) 903 may retrieve data from or write data to the CPU/GPU cache rather than reading/writing to memory 915, which may improve the speed of these operations. In some examples, a database cache may be created in which certain data from a database 921 is cached in a separate smaller database in a memory separate from the database, such as in RAM 906 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 905 are described separately, functionality of the various components may be combined and/or performed by a single component and/or multiple computing devices in communication without departing from the invention.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method. The method includes: accessing data associated with a plurality of transactions; generating, based on the data, a first tree-based machine learning model that contains a plurality of first nodes and a plurality of first branches interconnecting the plurality of first nodes; extracting a first rule from the first tree-based machine learning model; adjusting the data after the first rule has been extracted; generating, based on the adjusted data, a second tree-based machine learning model that contains a plurality of second nodes and a plurality of second branches interconnecting the plurality of second nodes; and extracting a second rule from the second tree-based machine learning model, wherein the second rule and the first rule have a correlation below a specified threshold.

Another aspect of the present disclosure involves a system that includes a non-transitory memory and one or more hardware processors coupled to the non-transitory memory and configured to read instructions from the non-transitory memory to cause the system to perform operations comprising: accessing machine learning training data corresponding to a plurality of historical transactions; and executing a plurality of cycles of a machine learning process, wherein the executing of each different cycle of the plurality of cycles outputs a different rule, and wherein the executing of each different cycle comprises: constructing, based on the machine learning training data, a tree model comprised of a plurality of tree nodes; determining that a particular traversal path for traversing the tree model is better at detecting historical transactions having a predefined label than other traversal paths for traversing the tree model; generating a rule corresponding to the particular traversal path as the rule outputted by the cycle; and adjusting the machine learning training data after the rule has been generated.

Yet another aspect of the present disclosure involves a non-transitory machine-readable medium having stored thereon machine-readable instructions executable to cause a machine to perform operations comprising: accessing data associated with a plurality of previous transactions; constructing, based on the data, a first machine learning model that contains a single first tree, wherein the single first tree comprises a plurality of first nodes connected together in a first configuration; traversing a plurality of paths of the single first tree; generating a first rule based on the traversing the plurality of paths of the single first tree, wherein the first rule corresponds to a first path of the plurality of paths of the single first tree, and wherein the first rule is configured to identify a first subset of the previous transactions that meet a predefined metric; revising portions of the data associated with the first subset of the previous transactions that meet the predefined metric; constructing, based on the data after the revising, a second machine learning model that contains a single second tree, wherein the single second tree comprises a plurality of second nodes connected together in a second configuration; traversing a plurality of paths of the single second tree; and generating a second rule based on the traversing the plurality of paths of the single second tree, wherein the second rule corresponds to a second path of the plurality of paths of the single second tree, and wherein the second rule is configured to identify a second subset of the previous transactions that meet the predefined metric, and wherein a correlation between the first rule and the second rule is below a specified threshold.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, while protected attributes are described, non-protected attributes that may unfairly bias a user and have no bearing on a decision to offer a benefit or protect are also part of present disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
accessing data associated with a plurality of transactions;
generating, based on the data, a first tree-based machine learning model that contains a plurality of first nodes and a plurality of first branches interconnecting the plurality of first nodes;
extracting a first rule from the first tree-based machine learning model;
adjusting the data after the first rule has been extracted;
generating, based on the adjusted data, a second tree-based machine learning model that contains a plurality of second nodes and a plurality of second branches interconnecting the plurality of second nodes; and
extracting a second rule from the second tree-based machine learning model, wherein the second rule and the first rule have a correlation below a specified threshold.

2. The method of claim 1, wherein each of the first nodes or each of the second nodes represents a different true or false condition.

3. The method of claim 1, wherein:
the data for each of the transactions comprises a metric having either a first status or a second status;
the first rule is extracted based on a traversal of the first tree-based machine learning model through a group of the first nodes;
a subset of the first nodes in the group is identified as having the first status for the metric; and
the adjusting the data comprises changing, for the subset of the first nodes, the first status to the second status.

4. The method of claim 3, wherein the metric comprises an occurrence of a predefined event associated with the transactions or a decline of the transactions.

5. The method of claim 3, wherein the first rule is extracted by:
identifying a plurality of potential traversals through the first tree-based machine learning model;
calculating a predefined performance indicator for each of the potential traversals; and
determining that the potential traversal with a highest value of the predefined performance indicator is the traversal based on which the first rule is extracted.

6. The method of claim 5, wherein:
the first tree-based machine learning model and the second tree-based machine learning model each comprises a Gradient Boosted Tree model; and
the predefined performance indicator comprises a gain calculated by the Gradient Boosted Tree model.

7. The method of claim 1, wherein the correlation between the first rule and the second rule is measured by a Jaccard similarity coefficient or a Pearson Correlation Coefficient.

8. The method of claim 1, wherein the first tree-based machine learning model and the second tree-based machine learning model have different tree configurations.

9. The method of claim 1, further comprising evaluating one or more further transactions at least in part by applying the first rule and the second rule to the one or more further transactions.

10. A system, comprising:
a processor; and
a non-transitory computer-readable medium having stored thereon instructions that are executable by the processor to cause the system to perform operations comprising:
receiving a request for a transaction;
accessing a plurality of rules that are generated by executing a plurality of cycles of a machine learning process, wherein the executing of each different cycle of the plurality of cycles outputs a different rule of the plurality of rules, and wherein the executing of each different cycle comprises:
constructing, based on machine learning training data corresponding to a plurality of historical transactions, a tree model comprised of a plurality of tree nodes;
determining that a particular traversal path for traversing the tree model is better at detecting historical transactions having a predefined label than other traversal paths for traversing the tree model;
generating a rule corresponding to the particular traversal path as the rule outputted by the cycle; and
adjusting the machine learning training data after the rule has been generated; and
processing, based on the plurality of rules, the request for the transaction.

11. The system of claim 10, wherein the operations further comprise facilitating, based on a plurality of rules obtained as a result of the executing the plurality of cycles of the machine learning process, a detection of one or more prospective transactions having the predefined label.

12. The system of claim 10, wherein:
a plurality of rules are obtained as a result of the executing the plurality of cycles of the machine learning process; and
a degree of correlation between any two of the plurality of rules is below a predefined threshold.

13. The system of claim 10, wherein each of the tree nodes comprises a satisfiable condition.

14. The system of claim 10, wherein the determining is based on a respective value of a performance indicator calculated for each traversal paths for traversing the tree model.

15. The system of claim 10, wherein:
in the machine learning training data, each of the historical transactions having the predefined label has a first status, and each of the historical transactions lacking the predefined label has a second status opposite the first status; and
the adjusting the machine learning training data comprises switching the first status to the second status for a subset of the historical transactions detected by the particular traversal path as having the predefined label.

16. The system of claim 15, wherein the executing the plurality of cycles is terminated when none of the historical transactions have the first status.

17. The system of claim 10, wherein in at least a subset of the plurality of cycles, a respective configuration of the respective tree model is different between the subset of the plurality of cycles.

18. A non-transitory machine-readable medium having stored thereon machine-readable instructions executable to cause a machine to perform operations comprising:
accessing data associated with a plurality of previous transactions;
constructing, based on the data, a first machine learning model that contains a single first tree, wherein the single first tree comprises a plurality of first nodes connected together in a first configuration;
traversing a plurality of paths of the single first tree;
generating a first rule based on the traversing the plurality of paths of the single first tree, wherein the first rule corresponds to a first path of the plurality of paths of the single first tree, and wherein the first rule is configured to identify a first subset of the previous transactions that meet a predefined metric;
revising portions of the data associated with the first subset of the previous transactions that meet the predefined metric;
constructing, based on the data after the revising, a second machine learning model that contains a single second tree, wherein the single second tree comprises a plurality of second nodes connected together in a second configuration;
traversing a plurality of paths of the single second tree; and
generating a second rule based on the traversing the plurality of paths of the single second tree, wherein the second rule corresponds to a second path of the plurality of paths of the single second tree, and wherein the second rule is configured to identify a second subset of the previous transactions that meet the predefined metric, and wherein a correlation between the first rule and the second rule is below a specified threshold.

19. The non-transitory machine-readable medium of claim 18, wherein:
the portions of the data comprises an indicator that indicates whether a particular previous transaction meets the predefined metric; and
the revising comprises flipping the indicator for the first subset of the previous transactions.

20. The non-transitory machine-readable medium of claim 18, wherein the first configuration and the second configuration are different from each other.
